(19) United States
(12) Patent Application Publication
(10) Pub. No.: US 2025/0227383 A1
(43) Pub. Date: Jul. 10, 2025

(54) HIGH DYNAMIC RANGE (HDR) PHOTOGRAPHY WITH SPLIT COMPUTE ON A WEARABLE DEVICE

(71) Applicant: Google LLC, Mountain View, CA (US)

(72) Inventors: Sean Ryan Francesco Fanello, San Francisco, CA (US); Ahmet Cengiz Öztireli, Zurich (CH); Sakar Khattar, Santa Clara, CA (US)

(21) Appl. No.: 18/993,644

(22) PCT Filed: Jul. 26, 2022
(86) PCT No.: PCT/US2022/074145

§ 371 Date: Jan. 13, 2025

(51) Int. Cl. H04N 23/741; G06T 3/40; H04N 23/66

(52) U.S. Cl. CPC H04N 23/741; G06T 3/40; H04N 23/66

(57) ABSTRACT

A method including capturing, by a wearable device, a plurality of images each having a first resolution, process, by the wearable device, the plurality of images to generate a first image having a second resolution, the second resolution being smaller than the first resolution, selecting, by the wearable device, a second image from the plurality of images having the first resolution based on a setting of the wearable device, and communicating, by the wearable device to a companion device, the first image and the second image. Further, processing, by the companion device, the first image, and merging, by the companion device, the processed first image with the second image to generate a high dynamic range (HDR) image.

### FIELD

Embodiments relate to digital photography processes on images captured using a wearable device.

### BACKGROUND

High dynamic range (HDR) photography is the standard for flagship mobile phones. The goal consists of designing a pipeline that takes as input an image burst (e.g., approximately ten, sometimes underexposed, frames). The image burst is then aligned, merged and denoised to generate one HDR image. The HDR image can be tone mapped and/or other image post-processing can be performed. The HDR can then be made accessible to the user of the mobile device.

### SUMMARY

A wearable device can be communicatively coupled to a companion device in order to split computing operations. In an example implementation, the wearable device can capture an image burst. The image burst can be used to generate a first image having a resolution that is smaller than the images of the image burst. The wearable device can select a second image from the image burst. The first image and the second image can be communicated to the companion device. The companion device can generate an HDR image by merging the first image and the second image.

In a general aspect, a device, a system, a non-transitory computer-readable medium (having stored thereon computer executable program code which can be executed on a computer system), and/or a method can perform a process with a method including capturing, by the wearable device, a plurality of images having a first number of pixels, processing, by the wearable device, the plurality of images to generate a first image having a second number of pixels that is less than the first number of pixels, selecting one of the plurality of images having the first number of pixels as a second image based on a setting of the wearable device, and communicating, by the wearable device to a companion device, the first image and the second image to generate a high dynamic range (HDR) image.

Implementations can include one or more of the following features, or any combination thereof. For example, the method can further include controlling, by the wearable device, the companion device to generate the HDR image based on the first image and the second image. The capturing of the plurality of images can be an image burst that includes capturing a series of images in response one trigger. The processing of the plurality of images to generate the first image can include compressing at least one of the first image and each of the plurality of images. The processing of the plurality of images to generate the first image can include downsampling at least one of the first image and each of the plurality of images.

The method can further include receiving a signal from the companion device, wherein the capturing of the plurality of images is in response to receiving the signal. The processing of the plurality of images to generate the first image can include reducing the number of pixels in each of the plurality of images to the second number of pixels, aligning corresponding pixels of the plurality of images, and merging the plurality of images to generate the first image. The processing of the plurality of images to generate the first image can include tone mapping and color tuning the image having the second number of pixels.

In another general aspect, a device, a system, a non-transitory computer-readable medium (having stored thereon computer executable program code which can be executed on a computer system), and/or a method can perform a process with a method including receiving, by the companion device from a wearable device, a first image having a first resolution and a second image having a second resolution, the first resolution being smaller than the second resolution, the first image and the second image being generated based on an image burst that includes capturing a series of images in response to one trigger, processing, by the companion device, the first image, and merging, by the companion device, the first image with the second image to generate a high dynamic range (HDR) image.

Implementations can include one or more of the following features, or any combination thereof. For example, the merging of the first image with the second image can includes inputting the first image and the second image into a machine learned model and generating the HDR image based on the first image with the second image using the machine learned model. The machine learned model can be trained using with a HDR ground truth image. The method can further include controlling, by the companion device, the wearable device to initiate the generation of the HDR image based on the first image and the second image. The method can further include communicating a signal to the wearable device, wherein the signal causes the wearable device to trigger the image burst.

In yet another general aspect, a device, a system, a non-transitory computer-readable medium (having stored thereon computer executable program code which can be executed on a computer system), and/or a method can perform a process with a method including capturing, by the wearable device, a plurality of images each having a first resolution, process, by the wearable device, the plurality of images to generate a first image having a second resolution, the second resolution being smaller than the first resolution, selecting, by the wearable device, a second image from the plurality of images having the first resolution based on a setting of the wearable device, communicating, by the wearable device to the companion device, the first image and the second image, processing, by the companion device, the first image, and merging, by the companion device, the processed first image with the second image to generate a high dynamic range (HDR) image.

Implementations can include one or more of the following features, or any combination thereof. For example, the processing of the plurality of images to generate the first image can include reducing the resolution of each of the plurality of images to the second resolution, aligning corresponding pixels of the plurality of images, and merging the plurality of images to generate the first image. The processing of the first image can include tone mapping and color tuning the first image. The merging of the first image with the second image can include inputting the processed first image and the second image into a machine learned model and generating the HDR image based on the processed first image second image using the machine learned model. The machine learned model can be trained using with a HDR ground truth image.

The method can further include controlling, by the companion device, the wearable device to initiate the generation of the HDR image based on the first image and the second image. The method can further include communicating, from the companion device to the wearable device, a signal that causes the wearable device to trigger the capturing of the plurality of images. The method can further include controlling, by the wearable device, the companion device to generate the HDR image based on the first image and the second image. The capturing of the plurality of images can be an image burst that includes capturing a series of images in response to one trigger.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a system for generating an HDR image according to an example implementation.

FIG. 2 illustrates a system for generating an HDR image according to an example implementation.

FIG. 3 illustrates a method of operating a wearable device to generate an HDR image according to an example implementation.

FIG. 4 illustrates a method of operating a companion device to generate an HDR image according to an example implementation.

FIG. 5A illustrates a wearable device configured to generate an HDR image according to an example implementation.

FIG. 5B illustrates a companion device configured to generate an HDR image according to an example implementation.

FIG. 6 illustrates a wearable device according to an example implementation.

FIG. 7 shows an example of a computer device and a mobile computer device according to at least one example embodiment.

It should be noted that these Figures are intended to illustrate the general characteristics of methods, and/or structures utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

There can be some difficulty in generating an HDR image on a wearable device (e.g., smart glasses) that include a camera. For example, wearable devices can have a limited computational budget. In other words, using wearable devices, executing the HDR processing pipeline can take too much time. For example, a wearable device can be 10× slower than standard processing time on a mobile phone. Therefore, using the same processing pipeline as typically used on the mobile phone on a wearable device can be undesirable from a user perspective.

Further, transferring the image burst from the wearable to a mobile phone capable of producing HDR images can take too much time (e.g., greater than 30 seconds) per image burst. In addition, transferring the image burst from the wearable to the mobile phone additionally can use an excessive amount of resources resulting in reducing the charge on the battery of the wearable device. Reducing the charge on the battery of the wearable device could make the wearable device unusable after capturing a few HDR images. A wearable device power constraint (e.g., a design criteria) can include ensuring that the battery charge is sufficient to enable the capturing and processing of images on the wearable device for a predefined number of image captures (e.g., greater than 200).

As discussed above, there can be problems with using the current HDR image processing technology on wearable devices. Example implementations solve these problems using a split compute on wearable devices process. The split compute on wearable devices process can include performing a portion of the image processing on the wearable device and a portion of the image processing on a companion device (e.g., a companion device communicably coupled to the wearable device). For example, in an example implementation, alignment and denoising can be performed by the wearable device on an image having a first (e.g., lower) resolution (e.g., number of pixels) based having the second (e.g., higher) resolution. Additional processing (e.g., tone mapping) can be performed on the image having the first (e.g., lower) resolution on the companion device. Then, an image having a second (e.g., higher) resolution can be merged with the image having the first (e.g., lower) resolution (after processing) to generate an HDR image.

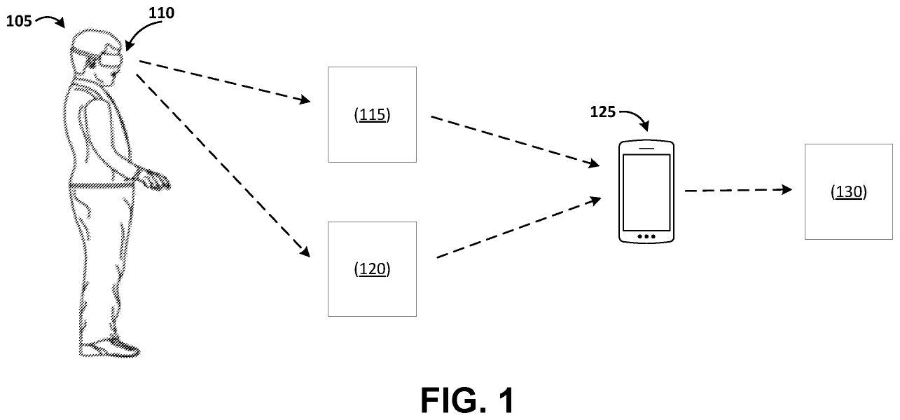

FIG. 1 illustrates a system for generating an HDR image according to an example implementation. As shown in FIG. 1, the system includes a user 105, a wearable device 110, and a companion device 125. Also shown in FIG. 1 is a first image 115, a second image 120 and an HDR image 130. The wearable device 110 can be configured to generate the first image 115 and the second image 120. The wearable device 110 can be configured to communicate the first image 115 and the second image 120 to the companion device 125. The companion device 125 can be configured to generate the HDR image 130 based on the first image 115 and the second image 120.

The wearable device 110 can be, for example, a smart glasses device (e.g., AR glasses device), a head mounted display (HMD), an AR/VR device, a wearable computing device, and the like. The user 105 is viewing a real-world view in any direction. The wearable device 110 can be configured to generate an image burst (e.g., approximately ten, sometimes underexposed, frames) of the real-world. The first image 115 and the second image 120 can be generated based on the image burst. For example, the wearable device 110 can capture the image burst as a plurality of images having a relatively high resolution (e.g., 12 megapixels). However, as discussed above, generating an HDR image from the plurality of images having a relatively high resolution on the wearable device 110 may not be desired. Therefore, the wearable device 110 can be configured to compress (e.g., reduce the number of pixels) the plurality of images having a relatively high resolution to a lower resolution (e.g., 3 megapixels). The plurality of images having a lower resolution can then be aligned, merged, and/or denoised (sometimes merging and denoising an image can be one process) to generate the first image 115. The resolution (e.g., number of pixels) of the low resolution second image can be large enough to ensure a visually (e.g., visually to a user) high quality HDR image can be generated, but small enough to minimize resource (e.g., processing, memory, battery) usage. The second image 120 can be selected from the plurality of images having a relatively high resolution (the second image 120 can sometimes be called a noisy image because the image has not been processed to remove noise associated with the image sensor used to capture the image). The second image 120 can be selected based on a setting of the wearable device. For example, a preconfigured or user setting can be stored in memory. The setting can indicate, for example, a first, a last, a middle, and/or the like in the time sequence of the plurality of images having a relatively high resolution (e.g., the image burst) is to be selected.

The companion device 125 can be configured to receive (e.g., via a wired and/or wireless connection) the first image 115 and the second image 120. The first image 115 can be further processed by the companion device 125. For example, the first image can be tone mapped. The companion device 125 can be configured to generate the HDR image 130 based on the first image 115 (e.g., the further processed first image 115) and the second image 120. For example, the first image 115 and the second image 120 can be merged using a machine learned model. The machine learned model can be a deep learning architecture (e.g., a trained neural network, U-Net, and the like). The machine learned model can be trained to generate an image (e.g., an HDR image) having the relatively high resolution (e.g., 12 megapixels) of the second image 120 and the post-processing (e.g., denoising) of the first image 115. In other words, the machine learned model can be trained to generate an HDR image based on the first image 115 and the second image 120.

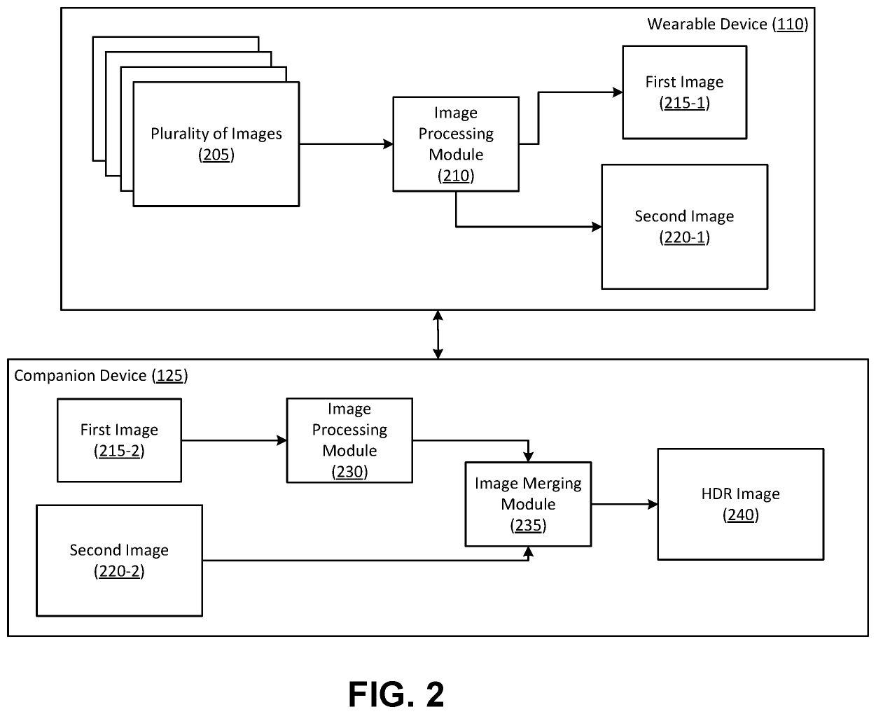

FIG. 2 illustrates a system for generating an HDR image according to an example implementation. As shown in FIG. 2, the system includes the wearable device 110 and the companion device 125. The wearable device includes a plurality of images 205, an image processing module 210, a first image 215-1, and a second image 220-1. The companion device includes a first image 215-2, a second image 220-2, an image processing module 230, an image merging module 235, and an HDR image 240.

The wearable device 110 can include a camera (e.g., an image sensor) configured to capture high resolution (e.g., 12 or more megapixels). The camera can be configured to capture images as an image burst. The image burst can include capturing a series of images in response to one trigger (e.g., button press, shutter press, instruction). The image burst can be a plurality of raw (e.g., unprocessed, uncompressed, low quality, underexposed, noisy, and/or the like) images. The number of images in the image burst can be variable and be based on the amount of light in the environment, a dynamic range of the scene, and/or the like. The image burst can be stored in a memory (e.g., a cache) as the plurality of images 205. The wearable device 110 can be configured to control the companion device 125 (e.g., communicate, signals, instructions and/or data) to generate an HDR image.

The image processing module 210 can be configured to generate the first image 215-1 and the second image 220-1 based on the plurality of images 205. Generating the first image 215-1 can include some image processing of the plurality of images 205. Generating the second image 220-1 can include selecting one of the plurality of images 205. The second image 120 can be selected based on a setting of the wearable device. For example, a preconfigured or user setting can be stored in memory. The setting can indicate, for example, a first, a last, a middle, and/or the like in the time sequence of the plurality of images 205 is to be selected.

The image processing module 210 can be configured to compress (e.g., reduce the number of pixels) the plurality of images 205. The image processing module 210 can use an image resizing algorithm to compress the plurality of images 205. The image resizing algorithm can proportionally reduce the number of pixels per row (width) and the number of pixels per column (height). For example, the width of each image can be reduced to n pixels, and the height can be proportionally reduced using an image resize programming function, such as, resize (e.g., resize(n, 0)). Other resizing algorithms, including machine learning models, are within the scope of this disclosure. In an example implementation, the plurality of images 205 can be compressed during an align and merge operation. For example, the plurality of images 205 can be downsampled during an align and merge operation.

The image processing module 210 can be configured to align and merge the plurality of images 205. Aligning and merging the plurality of images 205 can denoise the plurality of images 205. The plurality of images 205 can be aligned using a gaussian pyramid technique that moves from coarse to more fine alignments. Each level of the pyramid can be downsampled. Aligning the plurality of images 205 can include aligning corresponding pixels (e.g., pixels representing the same point are shifted to overlay each other) of the plurality of images 205. Aligning the plurality of images 205 can prevent blurring or ghosting due to motion. Merging the plurality of images 205 can generate one image and decrease noise associated with the resultant image (e.g., the first image 215-1) in relation to a reference image by including similar information from other aligned images. Merging can include using a variant of a Wiener filter to each tile (e.g., portion of an image) across the temporal dimension. Merging can include generating tiles (portions of an image) in each of the plurality of images and using a two-dimensional (2D) DFT across corresponding tiles resulting in a spatial frequency domain image merge. Merging can improve color accuracy in darker regions of the resultant image (e.g., the first image 215-1).

The wearable device 110 and the companion device 125 can be communicatively coupled using a wired (e.g., ethernet) and/or wireless (e.g., Bluetooth) standard. Accordingly, the first image 215-1 and the second image 220-1 can be communicated from the wearable device 110 to the companion device 125. In FIG. 2, the first image 215-2 and the second image 220-2 represent the respective same images as the first image 215-1 and the second image 220-1, except the first image 215-2 and the second image 220-2 are stored in a memory (e.g., cache) of the companion device 125. The companion device 125 may be configured to generate an HDR image from an image burst captured by a camera (e.g., image sensor) of the companion device 125. Therefore, an example implementation can use elements of the HDR pipeline associated with the companion device 125. The companion device 125 can be configured to control the wearable device 110 (e.g., communicate, signals, instructions and/or data) to initiate capture of an HDR image. For example, the companion device 125 can be configured to control the wearable device 110 to trigger the capture of the plurality of images 205 (e.g., trigger an image burst). Accordingly, the wearable device 110 can operate as an input or peripheral device (e.g., image and/or camera input) to the companion device 125.

The image processing module 230 can be configured to color and/or tone map (or tune) the first image 215-2. Color and/or tone mapping can be an optional operation. Color and/or tone mapping can be configured to map a pixel to a different color (e.g., RGB) value based on the color and/or tone associated with the pixel and/or surrounding pixels. Color and/or tone mapping can be configured to generate a more natural looking image. Color and/or tone mapping can be configured to reduce the dynamic range, or contrast ratio, of an entire image while retaining localized contrast. The image processing module 230 can be configured to perform other image finishing operations. For example, the image processing module 230 can be configured to perform lens shading correction, white balancing, de-mosaicking, chromatic aberration correction, sharpening, and/or the like.

The image merging module 235 can be configured to generate the HDR image 240 based on the first image 215-2 and the second image 220-2. The image merging module 235 can be configured to use a machine learned model to merge the first image 215-2 with the second image 220-2. The machine learned model can be a deep learning architecture (e.g., U-Net, CNN, and/or the like). The machine learned model can be trained to generate an image having the relatively high resolution (e.g., 12 megapixels) associated with the second image 220-2 and the post-processing (e.g., denoising) of the first image 215-2. In other words, the machine learned model can be trained to generate an HDR image based on the first image 215-2 and the second image 220-2.

The machine learned model can be a machine learned encoder-decoder architecture (e.g., U-Net, CNN, and/or the like) where an input image is input to the encoder and an output image is output from the decoder. A difference between the input image and the output image can be based on a training of the machine learned encoder-decoder architecture. The image merging module 235 can be configured to generate the HDR image 240 based on the first image 215-2 and the second image 220-2. Therefore, the machine learned encoder-decoder architecture can be used to merge the first image 215-2 and the second image 220-2 to generate the HDR image 240 where the first image 215-2 and the second image 220-2 can be input to the encoder and the HDR image 240 can be the output of the decoder.

As discussed above, the first image 215-2 has a first resolution and the second image 220-2 has a second resolution where the first resolution (e.g., 3 megapixels) is smaller than the second resolution (e.g., 12 megapixels). Therefore, the encoder of the machine learned encoder-decoder architecture can be configured to take two images of different sizes as input. The first element of the encoder can be a convolution element having a first number of channels as an input and a second number of channels (often fewer than the first number of channels) as output. The number of channels can be based on the number of pixels. For example, each pixel of can have a channel associated with red, green, and blue colors of the pixel (other representations of the pixel are within the scope of this disclosure). In an example implementation, the encoder first element (e.g., convolution) can include a sufficient number of input channels for the number of pixels associated with the first image 215-2 and the second image 220-2.

In an example implementation, the encoder can include two encoders and the output of the two encoders can be added together (e.g., a pixel-wise or channel wise summation) as the input to the decoder. The decoder can include a sufficient number of input channels for the added channels of the two encoders. In an example implementation, one of the two encoders can include a sufficient number of input channels for the number of pixels associated with the first image 215-2 and the other encoder can include a sufficient number of input channels for the number of pixels associated with the second image 220-2. As discussed above, the first image 215-2 has a first resolution and the second image 220-2 has a second resolution where the first resolution (e.g., 3 megapixels) is smaller than the second resolution (e.g., 12 megapixels). Therefore, the two encoders can have a different number of input channels. Alternatively, the two encoders can have a same number of input channels and the input of the encoder associated with the first image 215-2 can be configured to zero-pad the input channels that do not have an associated pixel input to a channel.

At the position where the two encoder outputs are added together, the number of channels can be equal in number or unequal in number. After adding the outputs together, the result (e.g., added channels) can be directly input to the decoder. Alternatively, the result can go through an additional encoder operation. For example, the result can go through another convolution operation. Example implementations have been discussed as though the output of two encoders is added together. However, in an example implementation, the element configured to add channels can be at an intermediate step (e.g., between two convolutions) of one of the encoders. Accordingly, the output of an encoder (e.g., the encoder associated with the first image 215-2) can be an input to the other encoder (e.g., the encoder associated with the first image 215-2) where channels can be added.

Training the machine learned model can include using HDR ground truth images. For example, training images representing the first image (e.g., a low resolution, image processed image) and the second image (e.g., a high resolution, raw image) can be input into the machine learned model and an output (e.g., predicted) image can be compared to an HDR ground truth image. A loss function can be used to evaluate the comparison. The machine learned model can include weights. The weights can be modified or learned during the training operation. For example, if the loss function evaluation results in a loss greater than a threshold, the weights can be modified, and the training continues. If the loss function evaluation results in a loss less than or equal to the threshold, the training ends. The training may include using a supervised learning technique.

Continuing the machine learned encoder-decoder architecture with two encoders example, training can include inputting a first training image (e.g., a low resolution, image processed image) into to an encoder and inputting a second training image (e.g., a high resolution, raw image) into another encoder. The first training image and the second training image can be encoded, and the associated channels added together. The added channels can be decoded to predict an image (e.g., an HDR image). The predicted image can be compared to an HDR ground truth image. A loss function can be used to evaluate the comparison and weights associated with the encoder(s) and the decoder can be modified based on the loss function evaluation. If the loss function evaluation results in a loss less than or equal to a threshold, the training of the machine learned encoder-decoder architecture with two encoders ends. In an example implementation, a plurality of first training image, second training image, and HDR ground truth image combinations can be used to train the machine learned encoder-decoder architecture with two encoders.

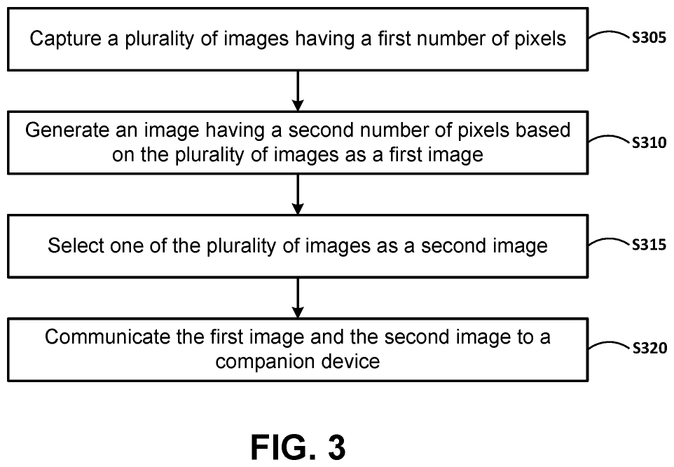

FIG. 3 illustrates a method of operating a wearable device to generate an HDR image according to an example implementation. As shown in FIG. 3, in step S305 a plurality of images having a first number of pixels are captured. All images of the plurality of images can have a same first number of pixels. For example, the plurality of images can be captured as an image burst of a wearable device. The image burst can be a plurality of raw (e.g., unprocessed, uncompressed, low quality, underexposed, noisy, and/or the like) images. All images of the plurality of images can have a first resolution. The first resolution can be a relatively high resolution (e.g., 12 megapixels). The first resolution can be a variable setting associated with the camera. However, the setting may not be changeable during the capture of an image burst. Therefore, each image of the image burst can have the same resolution (e.g., number of pixels).

In step S310 an image having a second number of pixels is generated based on the plurality of images as a first image. The first image can be generated based on all images of the plurality of images. Generating the image can include some image processing of the plurality of images. Generating the image can include aligning and merging the plurality of images. Aligning and merging the plurality of images can denoise the plurality of images. The plurality of images can be aligned using a gaussian pyramid technique that moves from coarse to more fine alignments. Each level of the pyramid can be downsampled. Aligning the plurality of images can prevent blurring or ghosting due to motion.

Merging the plurality of images can generate one image and decrease noise associated with the resultant image in relation to a reference image by including similar information from other aligned images. Merging can include using a variant of a Wiener filter to each tile (e.g., portion of an image) across the temporal dimension. Merging can improve color accuracy in darker regions of the resultant image. The plurality of images can be downsampled during an align and merge operation. The plurality of images can be compressed before, during, and/or after the align and merge operation. Downsampling and/or compressing the plurality of images and/or the image can generate an image having the second number of pixels. The second number of pixels can be smaller than the first number of pixels. Therefore, the image having a second number of pixels can have a lower resolution (e.g., 3 megapixels) as compared to the plurality of images.

In step S315 one of the plurality of images is selected as a second image. The second image can have the same number of pixels as each of the plurality of images. In other words, the second image can have a relatively high resolution (e.g., 12 megapixels). The second image can be an unprocessed or raw image. The second image 120 can be selected based on a setting of the wearable device. For example, a preconfigured or user setting can be stored in memory. The setting can indicate, for example, a first, a last, a middle, and/or the like in the time sequence of the plurality of images is to be selected. Alternatively, the setting can include a randomly selected image in the time sequence of the plurality of images. Alternatively, the setting can include determining a best image (e.g., some quality threshold) and selecting the best image image in the time sequence of the plurality of images.

In step S320 the first image and the second image are communicated to a companion device. For example, the wearable device and a companion device can be communicatively coupled using a wired (e.g., ethernet) and/or wireless (e.g., Bluetooth) standard. Accordingly, the first image and the second image can be communicated from the wearable device to the companion device.

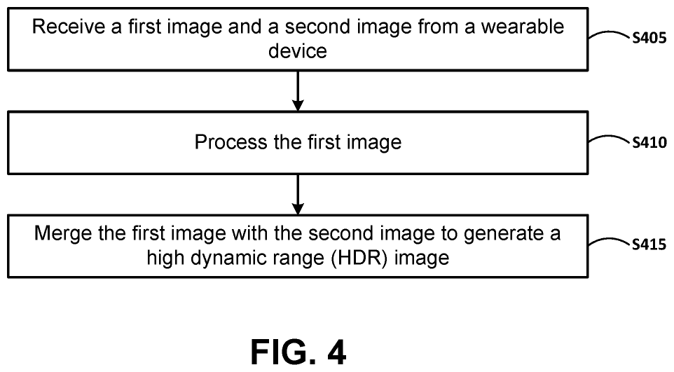

FIG. 4 illustrates a method of operating a companion device to generate an HDR image according to an example implementation. As shown in FIG. 4, in step S405 a first image and a second image are received from a wearable device. The first image can have a relatively low resolution (e.g., 3 megapixels) and the second image can have a relatively high resolution (e.g., 12 megapixels). The first image may be an image processed image and the second image may be an un-processed (e.g., not image processed) or raw image.

In step S410 the first image is processed. Processing the first image can include color and/or tone mapping (or tuning) the first image. Color and/or tone mapping can be an optional operation. Color and/or tone mapping can be configured to map a pixel to a different color (e.g., RGB) value based on the color and/or tone associated with the pixel and/or surrounding pixels. Color and/or tone mapping can be configured to generate a more natural looking image. Color and/or tone mapping can be configured to reduce the dynamic range, or contrast ratio, of an entire image while retaining localized contrast. Processing the first image can include other image finishing operations. For example, processing the first image can include performing lens shading correction, white balancing, de-mosaicking, chromatic aberration correction, sharpening, and/or the like.

In step S415 the first image is merged with the second image to generate a high dynamic range (HDR) image. For example, merging the first image with the second image can include use of a machine learned model to merge the first image with the second image. The machine learned model can be a deep learning architecture (e.g., U-Net). The machine learned model can be trained to generate an image having the relatively high resolution (e.g., 12 megapixels) associated with the second image and the post-processing (e.g., denoising) of the first image. In other words, the machine learned model can be trained to generate an HDR image based on the first image and the second image.

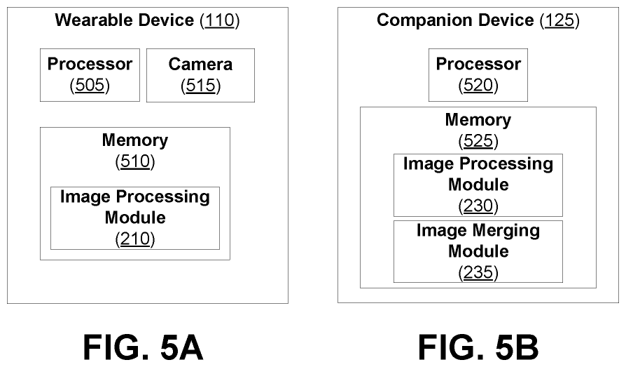

FIG. 5A illustrates a wearable device configured to generate an HDR image according to an example implementation. In the example of FIG. 5A, the wearable device 110 (e.g., a smart glasses) can include a computing system or at least one computing device and should be understood to represent virtually any computing device configured to perform the techniques described herein. As such, the device may be understood to include various components which may be utilized to implement the techniques described herein, or different or future versions thereof. By way of example, the system can include a processor 505, a memory 510 (e.g., a non-transitory computer readable memory) and a camera 515. The processor 505 and the memory 510 can be coupled (e.g., communicatively coupled) by a bus.

The processor 505 may be utilized to execute instructions stored on the at least one memory 510. Therefore, the processor 505 can implement the various features and functions described herein, or additional or alternative features and functions. The processor 505 and the at least one memory 510 may be utilized for various other purposes. For example, the at least one memory 510 may represent an example of various types of memory and related hardware and software which may be used to implement any one of the modules described herein.

The at least one memory 510 may be configured to store data and/or information associated with the device. The at least one memory 510 may be a shared resource. Therefore, the at least one memory 510 may be configured to store data and/or information associated with other elements (e.g., image/video processing or wired/wireless communication) within the larger system. Together, the processor 505 and the at least one memory 510 may be utilized to implement the techniques described herein. As such, the techniques described herein can be implemented as code segments (e.g., software) stored on the memory 510 and executed by the processor 505. Accordingly, the memory 510 can include the image processing module 210. As discussed above, image processing module 210 can be configured to generate a first image and a second image based on a plurality of images. Generating the first image can include some image processing of the plurality of images. Generating the second image can include selecting one of the plurality of images. The second image 120 can be selected based on a setting of the wearable device. For example, a preconfigured or user setting can be stored in memory. The setting can indicate, for example, a first, a last, a middle, and/or the like in the time sequence of the plurality of images is to be selected.

FIG. 5B illustrates a companion device configured to generate an HDR image according to an example implementation. In the example of FIG. 5B, the companion device (e.g., a mobile phone) can include a computing system or at least one computing device and should be understood to represent virtually any computing device configured to perform the techniques described herein. As such, the device may be understood to include various components which may be utilized to implement the techniques described herein, or different or future versions thereof. By way of example, the system can include a processor 520 and a memory 525 (e.g., a non-transitory computer readable memory). The processor 520 and the memory 525 can be coupled (e.g., communicatively coupled) by a bus.

The processor 520 may be utilized to execute instructions stored on the at least one memory 525. Therefore, the processor 520 can implement the various features and functions described herein, or additional or alternative features and functions. The processor 520 and the at least one memory 525 may be utilized for various other purposes. For example, the at least one memory 525 may represent an example of various types of memory and related hardware and software which may be used to implement any one of the modules described herein.

The at least one memory 525 may be configured to store data and/or information associated with the device. The at least one memory 525 may be a shared resource. Therefore, the at least one memory 525 may be configured to store data and/or information associated with other elements (e.g., image/video processing or wired/wireless communication) within the larger system. Together, the processor 520 and the at least one memory 525 may be utilized to implement the techniques described herein. As such, the techniques described herein can be implemented as code segments (e.g., software) stored on the memory 525 and executed by the processor 520. Accordingly, the memory 525 can include the image processing module 230 and the machine learning module 235. As discussed above, the image processing module 230 can be configured to color and/or tone map (or tuning) an image. The image processing module 230 can be configured to perform other image finishing operations. As discussed above, the image merging module 235 can be configured to generate an HDR image based on a first image (e.g., low resolution image) and a second image (e.g., high resolution image).

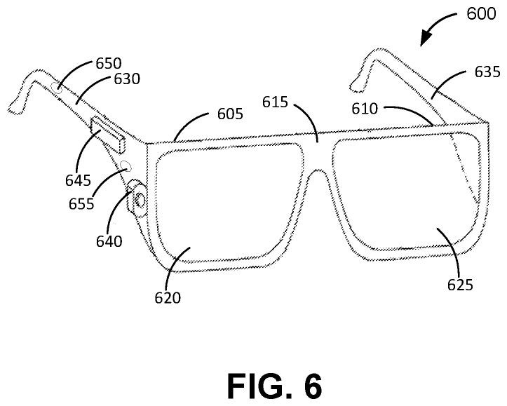

FIG. 6 illustrates a wearable device according to an example implementation. As shown in FIG. 6, a wearable device 600 includes lens frame 605, lens frame 610, center frame support 615, lens element 620, lens element 625, extending side-arm 630, extending side-arm 635, image capture device 640 (e.g., a camera), on-board computing system 645, speaker 650, and microphone 655.

Each of the frame elements 605, 610, and 615 and the extending side-arms 630, 635 can be formed of a solid structure of plastic and/or metal or can be formed of a hollow structure of similar material so as to allow wiring and component interconnects to be internally routed through the wearable device 600. Other materials can be possible as well. At least one of the lens elements 620, 625 can be formed of any material that can suitably display a projected image or graphic. Each of the lens elements 620, 625 can also be sufficiently transparent to allow a user to see through the lens element. Combining these two features of the lens elements can facilitate an augmented reality or heads-up display where the projected image or graphic is superimposed over a real-world view as perceived by the user through the lens elements.

The center frame support 615 and the extending side-arms 630, 635 are configured to secure the wearable device 600 to a user's face via a user's nose and ears, respectively. The extending side-arms 630, 635 can each be projections that extend away from the lens-frames 605, 610, respectively, and can be positioned behind a user's ears to secure the wearable device 600 to the user. The extending side-arms 630, 635 can further secure the wearable device 600 to the user by extending around a rear portion of the user's head. Additionally, or alternatively, for example, the wearable device 600 can connect to or be affixed within a head-mounted helmet structure. Other configurations for a wearable computing device are also possible.

The on-board computing system 645 is shown to be positioned on the extending side-arm 630 of the wearable device 600; however, the on-board computing system 645 can be provided on other parts of the wearable device 600 or can be remotely positioned from the wearable device 600 (e.g., the on-board computing system 645 could be wire-or wirelessly-connected to the wearable device 600). The on-board computing system 645 can include a processor and memory, for example. The on-board computing system 645 can be configured to receive and analyze data from the image capture device 640 (and possibly from other sensory devices) and generate images for output by the lens elements 620, 625.

The image capture device 640 can be, for example, a camera that is configured to capture still images and/or to capture video. In the illustrated configuration, image capture device 640 is positioned on the extending side-arm 630 of the wearable device 600; however, the image capture device 640 can be provided on other parts of the wearable device 600. The image capture device 640 can be configured to capture images at various resolutions or at different frame rates. Many image capture devices with a small form-factor, such as the cameras used in mobile phones or webcams, for example, can be incorporated into an example of the wearable device 600.

One image capture device 640 is illustrated. However, more image capture devices can be used, and each can be configured to capture the same view, or to capture different views. For example, the image capture device 640 can be forward facing to capture at least a portion of the real-world view perceived by the user. This forward-facing image captured by the image capture device 640 can then be used to generate an augmented reality where computer generated images appear to interact with or overlay the real-world view perceived by the user.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Split Compute Architecture can be an architecture that moves the app runtime environment to a remote compute endpoint or companion device, such as a phone, a server, the cloud, a desktop computer, the like, often referred to as a mobile device or a mobile phone for simplicity. In some implementations, data sources such as IMU and camera sensors can be streamed from the wearable device to the companion device. In some implementations, display content can be streamed from the companion device back to the wearable device. In some implementations, data streams, video/audio streams, a bi-directional control-streams, and/or the like can be communicated between the wearable device and the companion device. In some implementations, because a portion of the compute and rendering may not happen on the wearable device itself, the Split Compute Architecture can allow leveraging low-power MCU based systems. In some implementations, this can allow keeping power and ID in check, meeting design constraints, and the like. With codecs and networking, it is possible to sustain the required networking bandwidth in a low power manner. In some implementations, wearable devices could connect to more than one companion device at a given time. In some implementations, different companion devices could provide different services. In some implementations, with low-latency, high-bandwidth 5G connections becoming mainstream, the companion device could live in the cloud. In some implementations, wearable devices can communicate with a companion device over a to-be well-defined protocol. This architecture may be platform independent.

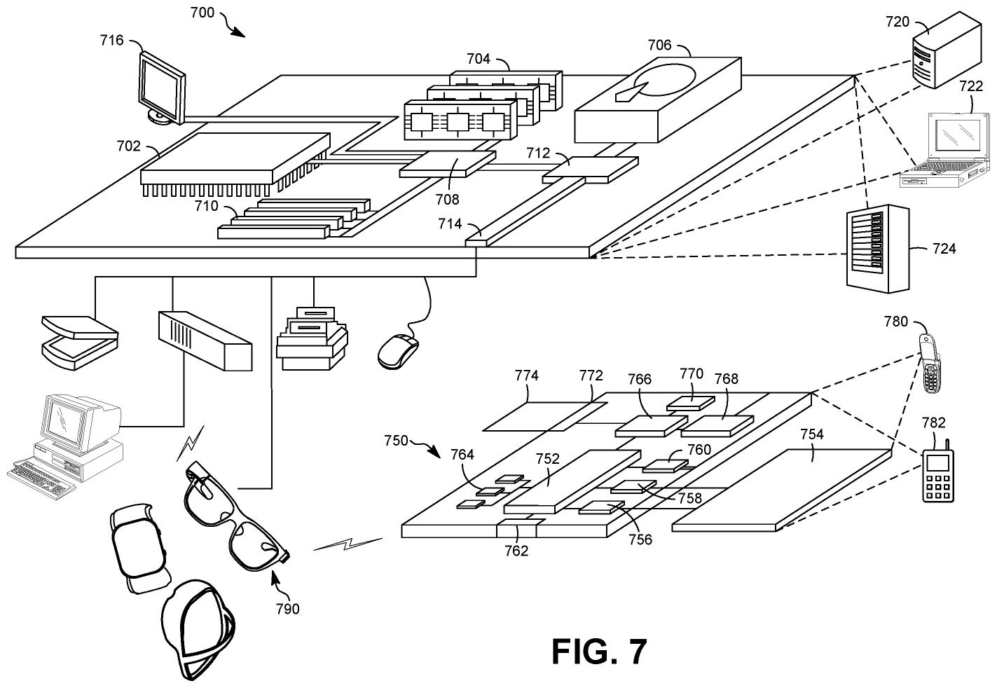

FIG. 7 illustrates an example of a computer device 700 and a mobile computer device 750, which may be used with the techniques described here (e.g., to implement the wearable device 110 and the companion device 125. The computing device 700 includes a processor 702, memory 704, a storage device 706, a high-speed interface 708 connecting to memory 704 and high-speed expansion ports 710, and a low-speed interface 712 connecting to low-speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high-speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer-or machine-readable medium, such as the memory 704, the storage device 706, or memory on processor 702.

The high-speed controller 708 manages bandwidth-intensive operations for the computing device 700, while the low-speed controller 712 manages lower bandwidth-intensive operations. Such allocation of functions is example only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display), and LED (Light Emitting Diode) or an OLED (Organic Light Emitting Diode) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In-Line Memory Module) card interface. Such expansion memory 774 may provide extra storage space for device 750 or may also store applications or other information for device 750. Specifically, expansion memory 774 may include instructions to carry out or supplement the processes described above and may include secure information also. Thus, for example, expansion memory 774 may be provided as a security module for device 750 and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation-and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the figure can include sensors that interface with an AR headset/HMD device 790 to generate an augmented environment for viewing inserted content within the physical space. For example, one or more sensors included on a computing device 750 or other computing device depicted in the figure, can provide input to the AR headset 790 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 750 can use the sensors to determine an absolute position and/or a detected rotation of the computing device in the AR space that can then be used as input to the AR space. For example, the computing device 750 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 750 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 750 when the computing device is incorporated into the AR space can cause a particular action to occur in the AR space.

In some implementations, a touchscreen of the computing device 750 can be rendered as a touchpad in AR space. A user can interact with the touchscreen of the computing device 750. The interactions are rendered, in AR headset 790 for example, as movements on the rendered touchpad in the AR space. The rendered movements can control virtual objects in the AR space.

In some implementations, one or more output devices included on the computing device 750 can provide output and/or feedback to a user of the AR headset 790 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 750 may appear as another object in a computer-generated, 3D environment. Interactions by the user with the computing device 750 (e.g., rotating, shaking, touching a touchscreen, swiping a finger across a touch screen) can be interpreted as interactions with the object in the AR space. In the example of the laser pointer in an AR space, the computing device 750 appears as a virtual laser pointer in the computer-generated, 3D environment. As the user manipulates the computing device 750, the user in the AR space sees movement of the laser pointer. The user receives feedback from interactions with the computing device 750 in the AR environment on the computing device 750 or on the AR headset 790. The user's interactions with the computing device may be translated to interactions with a user interface generated in the AR environment for a controllable device.

In some implementations, a computing device 750 may include a touchscreen. For example, a user can interact with the touchscreen to interact with a user interface for a controllable device. For example, the touchscreen may include user interface elements such as sliders that can control properties of the controllable device.

Computing device 700 is intended to represent various forms of digital computers and devices, including, but not limited to laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

Example implementations can be embodied as a non-transitory computer-readable storage medium comprising instructions stored thereon that, when executed by at least one processor, are configured to cause a computing system to perform a number of operations and/or steps based on the implementations described above. Example implementations can be embodied as an apparatus comprising means for performing a number of operations and/or steps based on the implementations described above. Example implementations can be embodied as an apparatus comprising at least one processor and at least one memory including computer program code, the at least one memory and the computer program code configured to, with the at least one processor, cause the apparatus at least to perform a number of operations and/or steps based on the implementations described above.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A non-transitory computer-readable storage medium comprising instructions stored thereon that, when executed by at least one processor, are configured to cause a wearable device to:
capture, by the wearable device, a plurality of images having a first number of pixels;
process, by the wearable device, the plurality of images to generate a first image having a second number of pixels that is less than the first number of pixels;
select, by the wearable device, one of the plurality of images having the first number of pixels as a second image based on a setting of the wearable device; and
communicate, by the wearable device to a companion device, the first image and the second image to generate a third image.

2. The non-transitory computer-readable storage medium of claim 1, the instructions further cause the wearable device to:
control, by the wearable device, the companion device to generate the third image based on the first image and the second image.

3. The non-transitory computer-readable storage medium of claim 1, wherein the capturing of the plurality of images is an image burst that includes capturing a series of images in response one trigger.

4. The non-transitory computer-readable storage medium of claim 1, wherein the processing of the plurality of images to generate the first image includes compressing at least one of the first image and each of the plurality of images.

5. The non-transitory computer-readable storage medium of claim 1, wherein the processing of the plurality of images to generate the first image includes downsampling at least one of the first image and each of the plurality of images.

6. The non-transitory computer-readable storage medium of claim 1, the instructions further cause the wearable device to:
receive a signal from the companion device, wherein the capturing of the plurality of images is in response to receiving the signal.

7. The non-transitory computer-readable storage medium of claim 1, wherein the processing of the plurality of images to generate the first image includes:
reducing the number of pixels in each of the plurality of images to the second number of pixels;
aligning corresponding pixels of the plurality of images; and
merging the plurality of images to generate the first image.

8. The non-transitory computer-readable storage medium of claim 1, wherein the processing of the plurality of images to generate the first image includes tone mapping and color tuning the image having the second number of pixels.

9. A non-transitory computer-readable storage medium comprising instructions stored thereon that, when executed by at least one processor, are configured to cause a companion device to:
receive, by the companion device from a wearable device, a first image having a first resolution and a second image having a second resolution, the first resolution being smaller than the second resolution, the first image and the second image being generated based on an image burst that includes capturing a series of images in response to one trigger;
process, by the companion device, the first image; and
merge, by the companion device, the first image with the second image to generate a third image.

10. The non-transitory computer-readable storage medium of claim 9, wherein the merging of the first image with the second image includes:
inputting the first image and the second image into a machine learned model; and
generating the third image based on the first image with the second image using the machine learned model.

11. (canceled)

12. The non-transitory computer-readable storage medium of claim 9, the instructions further cause the companion device to:
control, by the companion device, the wearable device to initiate the generation of the third-HDR image based on the first image and the second image.

13. The non-transitory computer-readable storage medium of claim 9, the instructions further cause the companion device to:
communicate a signal to the wearable device, wherein the signal causes the wearable device to trigger the image burst.

14. A system including a wearable device and a companion device, the system comprising:
at least one processor; and
at least one memory including computer program code;
the at least one memory and the computer program code configured to, with the at least one processor, cause the system to:
capture, by the wearable device, a plurality of images each having a first resolution;
process, by the wearable device, the plurality of images to generate a first image having a second resolution, the second resolution being smaller than the first resolution;
select, by the wearable device, a second image from the plurality of images having the first resolution based on a setting of the wearable device;
communicate, by the wearable device to the companion device, the first image and the second image;
process, by the companion device, the first image; and
merge, by the companion device, the processed first image with the second image to generate a third image.

15. The system of claim 14, wherein the processing of the plurality of images to generate the first image includes:
reducing the resolution of each of the plurality of images to the second resolution;
aligning corresponding pixels of the plurality of images; and
merging the plurality of images to generate the first image.

16. The system of claim 14, wherein the processing of the first image includes tone mapping and color tuning the first image.

17. The system of claim 14, wherein the merging of the first image with the second image includes:
inputting the processed first image and the second image into a machine learned model; and
generating the third image based on the processed first image second image using the machine learned model.

18. (canceled)

19. The system of claim 14, further comprising:
controlling, by the companion device, the wearable device to initiate the generation of the third image based on the first image and the second image.

20. The system of claim 14, further comprising:
communicating, from the companion device to the wearable device, a signal that causes the wearable device to trigger the capturing of the plurality of images.

21. The system of claim 14, further comprising:
controlling, by the wearable device, the companion device to generate the third image based on the first image and the second image.

22. The system of claim 14, wherein the capturing of the plurality of images is an image burst that includes capturing a series of images in response to one trigger.

23-28. (canceled)
